(19) United States
(12) Patent Application Publication
(10) Pub. No.: US 2010/0155567 A1
(43) Pub. Date: Jun. 24, 2010

(54) Preloading and Flex Resistant Support Column

(76) Inventors: Chi-Pin CHOU, Taichung Industrial Park (TW); Ming-Hung HSIEH, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/343,407

(22) Filed: Dec. 23, 2008

(51) Int. Cl. F16M 1/00

(52) U.S. Cl. 248/637

(57) ABSTRACT

A preloading and flex resistant support column comprises a support column and preloading member, wherein the support column is provided on one side thereof with a plurality of support portions arranged in straight lines along an axial direction of the support column, the preloading member is provided on one side thereof with a plurality of positioning portions arranged in curve lines along an axial direction of the preloading member. A plurality of screws is screwed through the positioning portions of the preload member into the support portions of the support column. The preloading member is such that its height is larger than its width, so it can produce a moment of inertia which is strong enough to support the support column from deformation.

### BACKGROUND OF THE INVENTION

1. Field of the Invention

The present invention relates to a support column for linear motion process machine, and more particularly to a preloading and flex resistant support column.

2. Description of the Prior Art

Linear motion processing machines mostly use a support column 10 (as shown in FIG. 1) with a large length-width ratio as a carrying means on demand, and the support column 10 can only provide support at both ends thereof.

However, as shown in FIG. 2, the support column 10 is likely to sag in the middle due to the effect of its gravity. The present method to prevent the middle deformation is to decrease the amount of material of the support column 10. Weight reduction may prevent deformation, however, it also reduces the loading capacity, so, when subjected to a load, the deformation of the support column 10 will get worse.

The present invention has arisen to mitigate and/or obviate the afore-described disadvantages.

### SUMMARY OF THE INVENTION

The primary objective of the present invention is to provide a preloading and flex resistant support column whose flex resistance is improved by the use of a preloading member.

To achieve the above objective, the preloading and flex resistant support column in accordance with the present invention comprises: a support column and preloading member, wherein the support column is provided on one side thereof with a plurality of support portions arranged in straight lines along an axial direction of the support column, the preloading member is provided on one side thereof with a plurality of positioning portions arranged in curve lines along an axial direction of the preloading member. The preloading member is such that its height is larger than its width. A plurality of screws is screwed through the positioning portions of the preload member into the support portions of the support column.

With the above arrangements, the present invention has the following advantages: The preloading member has a large height and small width, therefore, it can produce a moment of inertia which is strong enough to support the support column from deformation. Using screws to fixing the curve-line arranged support portions of the preloading member to the straight-line arranged positioning portions of the preloading member can make the preloading member support the support column from deformation, thus improving the loading capacity of the support column.

### BRIEF DESCRIPTION OF THE DRAWINGS

FIG. 1 is a perspective view of a conventional support column;

FIG. 2 is a side view of the conventional support column;

FIG. 3 is a perspective view of a support column in accordance with the present invention;

FIG. 3a is an enlarged view of a part of FIG. 3;

FIG. 4 is a side view of the support column in accordance with the present invention;

FIG. 4a is an enlarged view of a part of FIG. 4;

FIG. 4b is an enlarged view of a part of FIG. 4; and

FIG. 5 is an assembly view of the support column in accordance with the present invention.

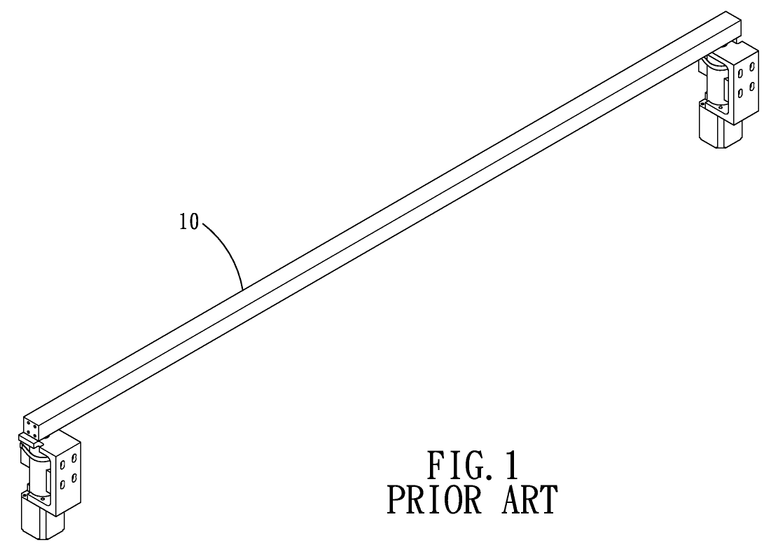

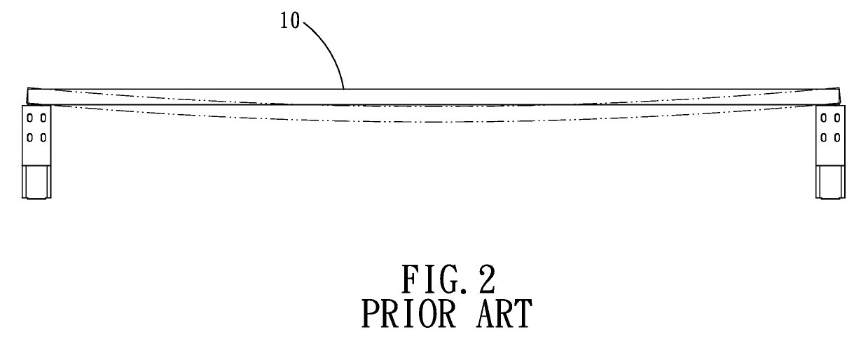

### DETAILED DESCRIPTION OF THE PREFERRED EMBODIMENT

The present invention will be clearer from the following description when viewed together with the accompanying drawings, which show, for purpose of illustrations only, the preferred embodiment in accordance with the present invention.

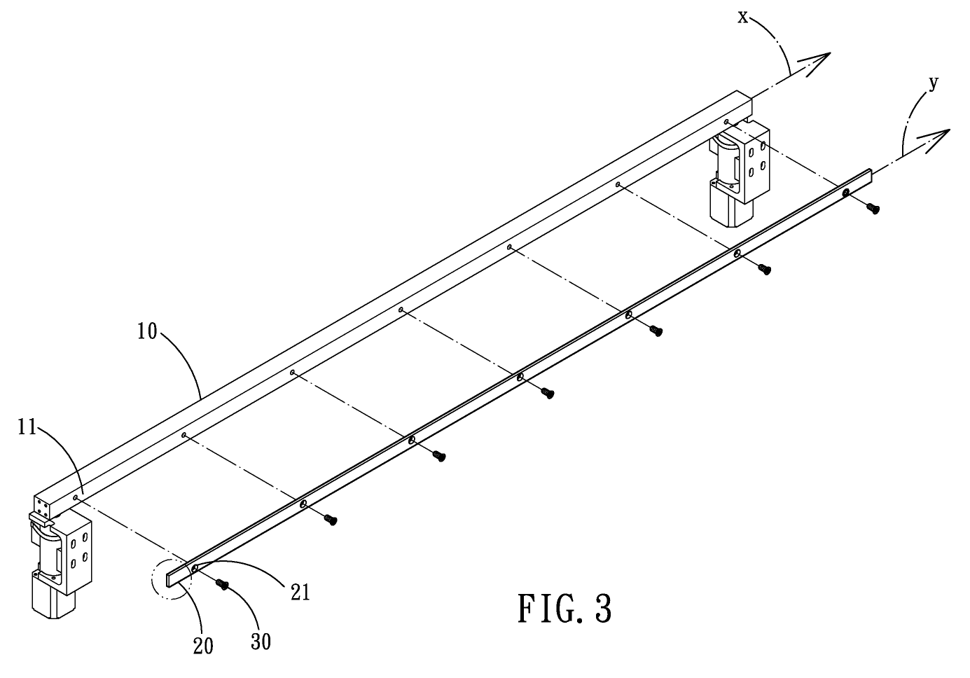

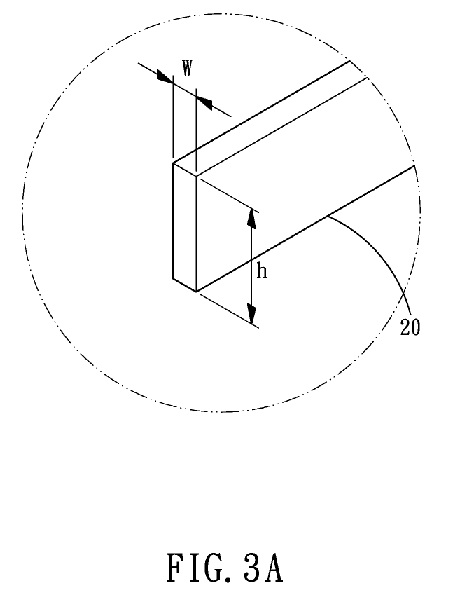

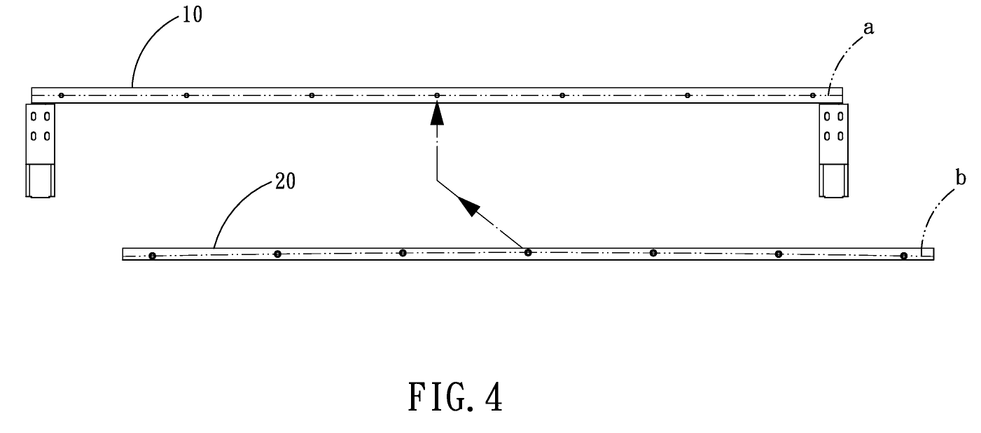

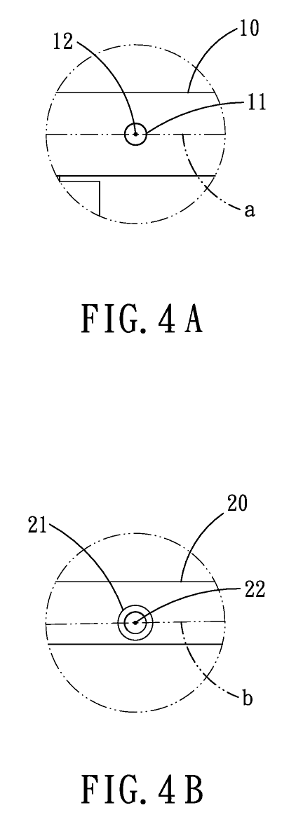

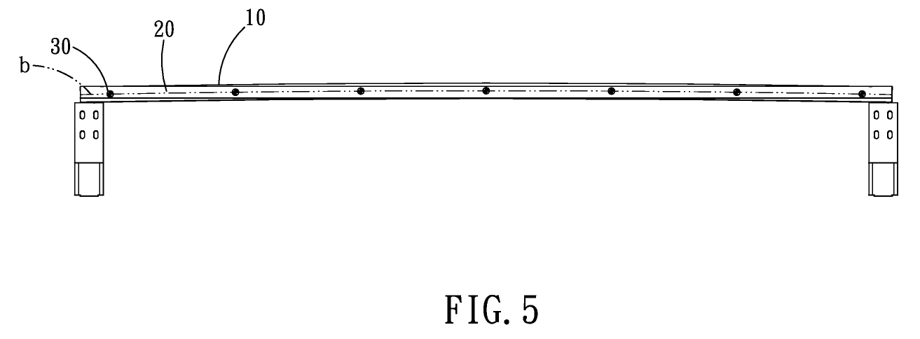

Referring to FIGS. 3-5, a support column in accordance with the present invention comprises a support column 10 and a preloading member 20. The support column 10 is polygonal-shaped in cross section, and its axial direction is designated by X. On one side of the support column 10 is formed a plurality of support portions 11 arranged in straight lines along the direction X, and there is at least one line of such support portions 11 on the support column 10. Each of the support portions 11 takes the form of a circular cavity with an axial center 12, and the centers 12 of the support portions 11 are connected to form a straight virtual reference line.

The preloading member 20 is fixed to the support portions 11 of the support column 10 by screws 30, and is provided with plural positioning portions 21 which are arranged in a curved line along the axial direction Y thereof. There is at least one line of such positioning portions 21. Each of the positioning portions 21 takes the form of a circular hole with an axial center 22, and the centers 22 of the positioning portions 22 are connected to form a curved virtual preloading line B. Each of the support portions 11 in the virtual reference line A is much larger in radius of curvature than any of the positioning portions 22 in the virtual preloading line B.

The preloading member 20 is w wide and h high. According to the equation of moment of inertia: I=w*h³/12, when the height h is much larger than the width w, the moment of inertia I will be very large, and similarly, when the height h is much smaller than the width w, the moment of inertia I will be very small. Suppose that the preloading member 20 has a constant cross section (200 mm²), when the height h is greater than the width (h=20 mm, w=10 mm), the resultant moment of inertia I will be: I=hw³/12=6666.67 mm⁴, when the height h is smaller than the width (h=10 mm, w=20 mm), the resultant moment of inertia I will be: I=hw³/12=1666.67 mm⁴. It shows that when the preloading member 20 is such that its height h is larger than its width w, the preloading member 20 is greater in rigidity than the support column 10.

When the preloading member 20 is fixed to the support column 10 by screwing screws 30 through its positioning portions 21 into the corresponding support portions 11 of the support column 10, respectively, it can support the support column 10 and prevent it from deformation since the preloading member 20 has a greater rigidity than the support column 10.

While we have shown and described various embodiments in accordance with the present invention, it is clear to those skilled in the art that further embodiments may be made without departing from the scope of the present invention.

What is claimed is:

1. A preloading and flex resistant support column comprising:
a support column being provided on one side thereof with a plurality of support portions arranged in straight lines along an axial direction of the support column;
a preloading member being provided on one side thereof with a plurality of positioning portions arranged in curve lines along an axial direction of the preloading member, the preloading member being such that its height is larger than its width; and
a plurality of screws screwed through the positioning portions of the preload member into the support portions of the support column.

2. The preloading and flex resistant support column as claimed in claim 1, wherein each of the support portions has an axial center, and the axial centers of the support portions are connected to form a straight virtual reference line.

3. The preloading and flex resistant support column as claimed in claim 2, wherein each of the support portions takes the form of a circular cavity.

4. The preloading and flex resistant support column as claimed in claim 1, wherein each of the positioning portions has an axial center, and the axial centers of the positioning portions are connected to form a curved virtual preloading line.

5. The preloading and flex resistant support column as claimed in claim 4, wherein each of the positioning portions is in the form of a circular hole.
